(19) United States
(12) Patent Application Publication
(10) Pub. No.: US 2015/0220988 A1
(43) Pub. Date: Aug. 6, 2015

(54) METHOD AND APPARATUS FOR ASSOCIATING HOTKEYS WITH POINT OF INTEREST INFORMATION

(71) Applicant: Nokia Corporation, Espoo (FI)

(72) Inventors: Dhaval Jitendra Joshi, Bangalore (IN); Pankaj Jaiprakash Nathani, Gujarat (IN)

(21) Appl. No.: 14/420,992

(22) PCT Filed: Sep. 25, 2013
(86) PCT No.: PCT/IB2013/058832

§ 371 Date: Feb. 11, 2015

(30) Foreign Application Priority Data
Oct. 1, 2012 (IN) 4103/CHE/2012

(51) Int. Cl. G06Q 30/02; H04W 4/16; H04M 7/00; H04W 4/02; H04M 3/42

(52) U.S. Cl. CPC G06Q 30/0261; G06Q 30/0267; H04W 4/021; H04M 3/42348; H04M 7/0036; H04W 4/16

(57) ABSTRACT

An approach for associating one or more hot keys with point of interest information is described. A hot key activation platform causes, at least in part, an association of one or more hot keys with point of interest information. Activation of the one or more hot keys at at least one device causes, at least in part, a presentation of the point of interest information at the at least one device.

### BACKGROUND

Service providers and device manufacturers (e.g., wireless, cellular, etc.) are continually challenged to deliver value and convenience to consumers by, for example, providing compelling network services. One area of interest is providing device users with on demand access to location based services such as mapping applications. In some instances, the location information may be presented in conjunction with advertisements, offers and other incentives related to various locations or points of interest presented via the mapping application. Unfortunately, constraints such as device screen size or user location limit the visibility and thus effectiveness of the advertisements to entice device users. Also, there is currently no way to directly correlate broadcast based advertisements (e.g., radio or television advertisements) to various locations or points of interest by way of a mapping application.

### SOME EXAMPLE EMBODIMENTS

Therefore, there is a need for associating one or more hot keys with point of interest information.

According to one embodiment, a method comprises causing, at least in part, an association of one or more hot keys with point of interest information. Activation of the one or more hot keys at at least one device causes, at least in part, a presentation of the point of interest information at the at least one device.

According to another embodiment, an apparatus comprises at least one processor, and at least one memory including computer program code for one or more computer programs, the at least one memory and the computer program code configured to, with the at least one processor, cause, at least in part, the apparatus to associate one or more hot keys with point of interest information. Activation of the one or more hot keys at at least one device causes, at least in part, a presentation of the point of interest information at the at least one device.

According to another embodiment, a computer-readable storage medium carries one or more sequences of one or more instructions which, when executed by one or more processors, cause, at least in part, an apparatus to associate one or more hot keys with point of interest information. Activation of the one or more hot keys at at least one device causes, at least in part, a presentation of the point of interest information at the at least one device.

According to another embodiment, an apparatus comprises means for causing, at least in part, an association of one or more hot keys with point of interest information. Activation of the one or more hot keys at at least one device causes, at least in part, a presentation of the point of interest information at the at least one device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of associating one or more hot keys with point of interest information, according to one embodiment;

FIG. 2 is a diagram of the components of a hot key activation platform, according to one embodiment;

FIGS. 3A-3C are flowcharts of processes for associating one or more hot keys with point of interest information, according to various embodiments;

FIGS. 4A-4C are diagrams of user interfaces utilized in the processes of FIGS. 3A-3C, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus and computer program for associating one or more hot keys with point of interest information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to points of interest as presented with respect to a mapping application, it is contemplated the approach described herein may be used with any location based service for supporting user travel, location finding and interaction within a given environment. This may include, for example, an event planning application, a social media application, a deal finder/shopping application, a sightseeing application, a travel service or the like.

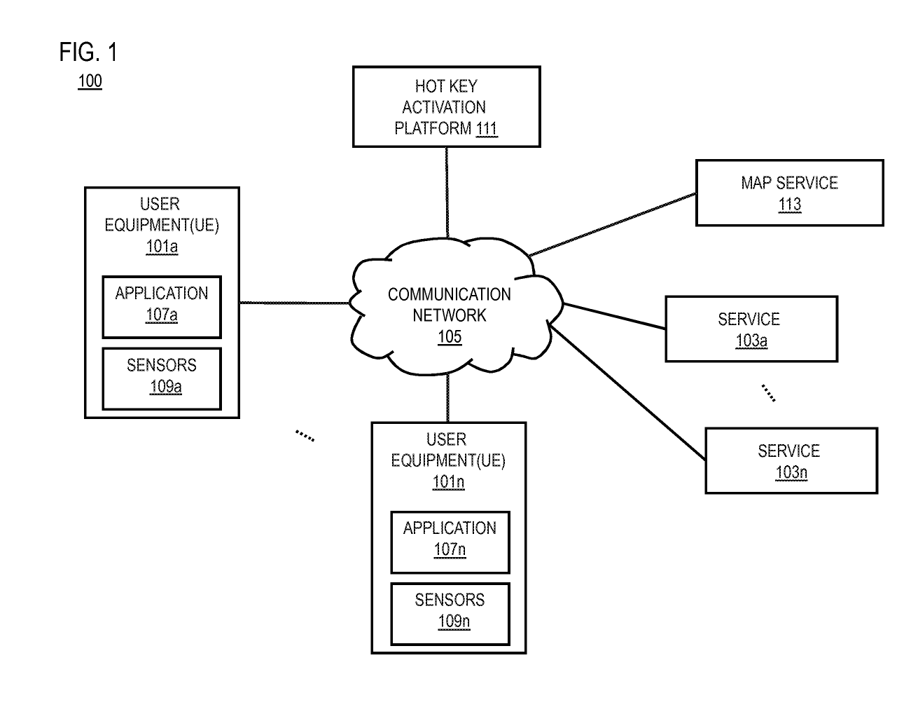

FIG. 1 is a diagram of a system capable of associating one or more hot keys with point of interest information, according to one embodiment. For the purpose of illustration, point of interest (POI) information may include data for conveying details about or in association with a specific POI (e.g., restaurant, attraction, venue). For example, the POI information may include a name, location or description of the POI. In addition, the POI information may include one or more advertisements, offers, incentives, deals or marketing promotions related to or associated with the POI. As will be discussed more fully herein, this may include a radio broadcast, a television broadcast, an internet or other network broadcast or any other communication pertaining to a POI.

As noted previously, device users regularly rely on location based services, such as mapping applications and corresponding services to access information regarding a travel route, location details or points of interest (POI). By way of such tools, users can access maps for detailing a route as well as information regarding landmarks, shopping centers, attractions and other POI they may encounter with respect to the route of based on a location. Typically, the mapping application or service is provided by a location based service provider for free use by device users. As such, the service provider may enable the presentment of various advertisements, incentives, offers, marketing data and other information along with location and POI—i.e., as a means of revenue generation.

Unfortunately, the advertisements and other information have very limited exposure to the user due to constraints such as limited device screen size or the user's location. Resultantly, some of the advertisements are never discovered or seen by the user, which limits the opportunity for advertisers as well as the provider of the location based service to attract user interest. Also, most location based services do not support means of interacting and/or integrating with other communication mediums such as radio and television; as there is no way to connect what a user listens to or views with the location based service the user employs via their device.

To address this problem, a system 100 of FIG. 1 introduces the capability to invoke the presentment of POI information to a user interface of a mapping application (e.g., application 107a-107n) based on activation of a hot key via a user device (e.g., user equipment (UE) 101a-101n). By way of example, the hot key may include any action buttons or combinations thereof for activating a device function, software function or the service function associated with the UE 101a-101n (referred to herein collectively as UE 101). In certain embodiments, the function invoked by the hot key may include activation of a graphic, icon, video file or other audio file associated with a POI based on POI information conveyed via a communication medium (e.g., a radio broadcast). Thus, corresponding POI information for depicting the POI in association with a map or other location may be presented upon activation of the hot key.

For example, in the case where POI information is conveyed as television advertisement, the advertisement may include an instruction for the user to select a specific hot key to invoke a particular incentive/offer or identify a location corresponding to the POI. Upon selection of the hot key by a user at UE 101, an icon representative of the POI may be presented as anchored to a map for depicting the location where the incentive/offer may be redeemed. In the case of a restaurant (as the POI), the icon may be a logo depicting the restaurant brand or a graphic for indicating a signature menu item of the restaurant.

As another example with respect to a restaurant related POI, selection of the hot key as prompted by the television advertisement may cause activation of a window for executing a video file, audio file or other media file related to the restaurant (e.g., a commercial, customer testimony, offer details). Under this scenario, the window for presenting the media file may be anchored to a location upon the map representing the location of the restaurant. It is noted that the hot keys may include any implementation of action buttons presented in connection with a location based service for display to the UE 101. This includes graphical buttons for depicting a keypad, dials or keyboard. Also, the hot keys may be physical buttons of the mobile device, such as the keypad, dials or a power button of the UE 101.

In certain embodiments, the system 100 includes a hot key activation platform 111 that is configured to operate in connection with the applications 107a-107n (referred to herein collectively as applications 107) or a corresponding mapping service 113 for enabling activation of a hot key function. By way of example, the hot key activation platform 111 enables the linking and/or correlating of POI information, such as that presented via a radio broadcast, with a hot key of the UE 101. The correlation may be determined based on contextual parameters, including a temporal parameter, location parameter or activity parameters pertaining to the UE 101 or user thereof. It is noted that the POI information conveyed to the user for prompting user selection of a hot key may be that which is presented directly by the UE 101 or another presentation medium (e.g., standalone television or radio device). In the case where conveyance is via the UE 101 directly, this is performed by a television or radio player application of the UE 101.

In addition, the hot key activation platform 111 determines whether one or more operating parameters for associating a hot key with the point of interest information are fulfilled. The operating parameters may include conditions for which activation of a hot key is allowed or relevant for generation and/or presentment of POI information in association with the mapping application 107 or service 113. In certain embodiments, the operating parameters dictate whether POI information as conveyed (e.g., broadcast) is suitable for activation in connection with user selection of a hot key.

By way of example, the hot key activation platform 111 may retrieve context information gathered by the various sensors 109a-109n (referred to herein collectively as sensors 109) of the UE 101. This may include current time, location and activity information; wherein the contextual parameters to be retrieved are based on requirements established by a provider of the POI information. For instance, when the provider of the POI information is an advertiser that providers radio advertisements to be included as part of the programming queue of a radio station, the contextual parameters may be specified by the advertiser accordingly. It is noted that the context information may therefore be continuously or periodically retrieved from the sensors 109 for processing by the hot key activation platform 111 in connection with a mapping application 107 or service 113.

Once retrieved, the platform 111 further compares these contextual parameters against the operating parameters to determine if the UE 101 or user thereof can activate a hot key. The operating parameters may include, for example, a period of time during which the association is active. In the case of a radio broadcast, for instance, the period of time may correspond to a time interval or scheduled time of play of the broadcast by a certain radio station. As another example, the operating parameters may include a proximity, location or activity for which the association is active. Hence, in the case of POI information presented as a television broadcast, the proximity or location may correspond to a certain zip code, city, region, television broadcast zone, or the like. Likewise, the activity may correspond to an event or action in which the user or UE 101 is engaged, such as a concert, listening to a television, radio or network broadcast, participation in a video conference, etc.

It is noted per the aforementioned examples that a hot key may be activated in connection with a UE 101 when the user and/or UE 101 is: at the correct location associated with the POI, within a correct proximity of the POI, selecting the hot key at the correct time or during the correct time window (e.g., within 10 minutes) of conveyance of the POI information, during user engagement of the correct event or activity type related to the POI information, or a combination thereof. It is noted that various other conditions under which the association is active may be further specified accordingly.

In certain embodiments, the hot key activation platform 111 maintains a hot key map, which is a data file for specifying to a UE 101 the above described operating parameters and contextual parameters. As such, the hot key map provides a mapping between a hot key and the specific function to be invoked relative to corresponding POI information, the contextual parameters and the operating parameters. The hot key map is generated by the provider of the POI information, which may include one or more providers of information, advertisements, offers or other services 103. By way of example, the providers may subscribe to the hot key activation platform 111 for enabling the sharing of POI information in conjunction with a function to be executed via a hot key of the UE 101 of respective users. Hence, by way of this implementation, both users of UE 101 and individual providers of services 103 may interact with the platform 111 for facilitating the associating of one or more hot keys with point of interest information.

Based on the above, the hot key map may be readily adapted to accommodate different contextual scenarios. This includes different locations of respective POI, different times of day and different activities. For example, the hot key map may specify the hot key labeled “6” on the dial pad of a UE 101 corresponds to a function for activating an icon representative of Sporting Goods Store A at location A. Under this scenario, POI information related to Sporting Goods Store A may be conveyed to the user along with an instruction for the user to dial “6” via the dial pad of their device. When the user is at location B, the same hot key may correspond to a function for activating an icon pertaining to Restaurant B. Thus, the key map enables the same hot key to be configurable for different locations.

As another example, the hot key map may specify the up volume button of the UE 101 corresponds to a function for activating a video pertaining to a Gymnasium at location C based on running activity of the user. Under this scenario, POI information related to the Gymnasium may be conveyed to the user along with an instruction for the user to press the up volume button of their device. When the user is listening to music at the same location, the same hot key may correspond to a function for activating an icon pertaining to a music goods store. Thus, the hot key map enables the same hot key to be configurable for different locations as well as for different user activity types.

It is noted that the hot key map may be conveyed to the user at the UE 101. By way of example, the hot key map is conveyed as broadcast programming. Hence, the hot key map may be provided through one or more radio broadcasts, one or more television broadcasts, one or more network broadcasts, or a combination thereof. In one embodiment, the hot key map may be provided via a data carrier signal associated with the broadcasts. For example, for a radio broadcast, the hot key map and/or related data may be sent over on a Radio Data System (RDS) protocol and/or a Radio Broadcast Data System (RBDS) protocol. In some embodiments, the hot key map may be conveyed in conjunction with the POI information, e.g., as instructions for the user. Still further, in certain instances, the hot key map may cause an adapting of the graphical depiction of the hot key to represent the POI. For example, a graphical depiction of the dial pad key labeled “6” may be replaced with an icon depicting and/or associated with the POI.

In certain embodiments, the hot key activation platform 111 also facilitates various reporting activities. The reports may be generated for the various providers of services 103a-103n as well as for the provider of the map service 113. By way of example, the report may indicate a number of times one or more hot keys have been activated per conveyed POI information. As such, the amount of user interest in POI information or the effectiveness of a related marketing campaign may be objectively measured.

As shown in FIG. 1, the system 100 comprises user equipment (UE) 101 having connectivity to the hot key activation platform 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, hot key activation platform 111, applications 107, mapping service 113 and various services 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

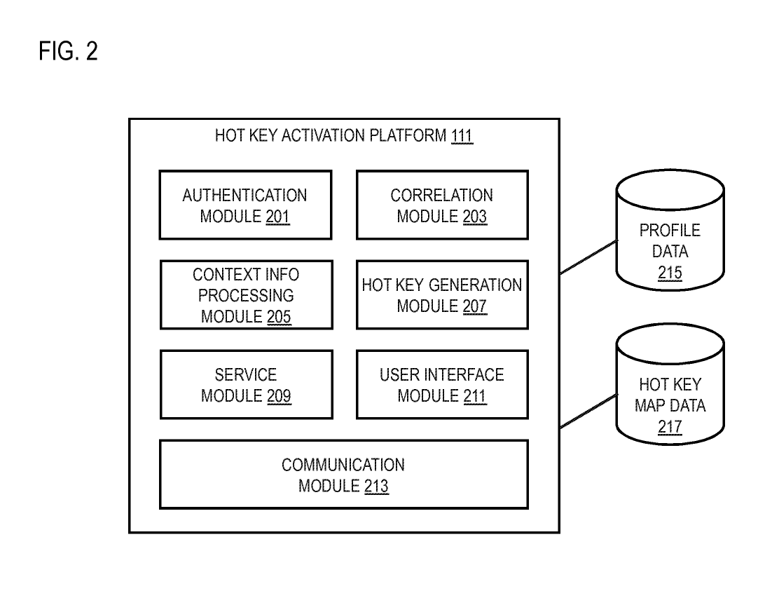

FIG. 2 is a diagram of the components of a hot key activation platform, according to one embodiment. By way of example, the hot key activation platform 111 includes one or more components for associating one or more hot keys with point of interest information. It is contemplated that the functions of these components may be combined in one or more components or performed by other components of equivalent functionality. In this embodiment, the hot key activation platform 111 includes an authentication module 201, correlation module 203, context information processing module 205, hot key generation module 207, service module 209, user interface module 211 and communication module 213.

The aforementioned modules 201-213 of the hot key activation platform 111 may also access one or more databases 215 and 217 or performing various executions. This includes, for example, a profile database 215 for maintaining profile information related to one or more users or one or more services 103 subscribed to and/or associated with the hot key activation platform 111. Also, a hot key map database 217 for maintaining hot key map data may be accessed.

In one embodiment, an authentication module 201 authenticates users and UE 101a-101n for interaction with the hot key activation platform 111. By way of example, the authentication module 201 receives a request to subscribe to the hot key activation platform 111 for associating a hot key with point of interest information. The subscription process may include, for example, selection of an “opt-in” option, wherein users of the hot key activation platform 111 permit sharing of their context information (e.g., location information, position information and temporal information) as collected via one or more sensors 109 of UE 101. In addition, various input data required for a user to subscribe to a location based service or other service 103 may be established accordingly. This input data may be provided to a service module 209, which facilitates the accessing of POI information from the various services 103 or map information from a map service 113. Preferences and settings information may be referenced to a specific user, user device, or combination thereof and maintained as profile data 117.

It is further noted, in certain embodiments, that the subscription process may correspond to the services 103. By way of example, the services may submit hot key map data 217 for indicating a mapping between POI information and a hot key of a device. Per the hot key map data 217, the providers of the services 103 may also specify various contextual parameters and operating parameters for facilitating execution of a hot key.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the hot key activation platform 111 (e.g., as enabled by user interface module 211). Profile data pursuant to registration may be cross referenced as part of the login process. Alternatively, the login process may be performed through automated association of profile settings maintained as profile data 215 with an IP address, a carrier detection signal of a user device, mobile directory number (MDN), subscriber identity module (SIM) (e.g., of a SIM card), radio frequency identifier (RFID) tag or other identifier.

In one embodiment, the correlation module 203 correlates POI information (e.g., as played via a radio broadcast or provided via a data carrier signal (e.g., RDS) of the radio broadcast) to a hot key of a UE 101. By way of example, the correlation module 203 enables the linking and/or correlating of POI information, such as that presented via a radio broadcast, by way of the hot key map data 217. The correlation may be determined based on contextual parameters, including a temporal parameter, location parameter or activity parameters pertaining to the UE 101 or user thereof. In addition, the correlation module 203 determines whether one or more operating parameters for associating a hot key with the point of interest information are fulfilled. The operating parameters may include conditions for which activation of a hot key is allowed or relevant for generation and/or presentment of POI information in association with the mapping application 107 or service 113.

Based on processing of the contextual parameters, as gathered by the context information processing module 205, the correlation module 203 determines whether the operating parameters are met. When the operating parameters (e.g., conditions) are met, the hot key generation module 207 is initiated for enabling activation of the function associated with the hot key. By way of example, the hot key function may correspond to a device function, software function or the service function associated with the UE 101. In certain embodiments, the function invoked by the module 207 may include activation of a graphic, icon, video file or other audio file associated with a POI based on POI information conveyed via a communication medium (e.g., a radio broadcast).

In one embodiment, the context information processing module 205 receives context information as gathered by the sensors 109 of respective UE 101. Once received, the context information processing module 205 analyzes the context information 113 to determine the relative location, time, position and other information regarding the user and/or UE 101. This context information is then passed on to the correlation module 203 for processing against the hot key map data 217.

In one embodiment, the user interface module 211 enables presentment of a graphical user interface for presenting POI information or hot key map information in connection with a map. By way of example, the user interface module 211 employs various application programming interfaces (APIs) or other function calls corresponding to the application 107 of UE 101; thus enabling the display of graphics primitives such as menus, buttons, data entry fields, etc., for generating the user interface elements. In addition, the user interface module 211 enables the rendering of icons, graphics, media data and other information pertaining to the POI information.

It is noted also that the user interface module 211 may be configured to operate in connection with augmented reality (AR) processing techniques, wherein various different applications, graphic elements and features may interact within the same view at the UE 101. For example, the user interface module 211 may coordinate the presentment of augmented reality images in conjunction with images for depicting POI information relative to a map.

In one embodiment, a communication module 213 enables formation of a session over a network 105 between the hot key activation platform 111, the map service 113 and the services 103. By way of example, the communication module 213 executes various protocols and data sharing techniques for enabling collaborative execution between a subscriber's UE 101a-101n (e.g., mobile devices, laptops, smartphones, tablet computers, desktop computers) and the hot key activation platform 111 over the network 105.

The above presented modules and components of the hot key activation platform 111 can be implemented in hardware, firmware, software, or a combination thereof. Though depicted as a separate entity in FIG. 1, it is contemplated that the hot key activation platform 111 may be implemented for direct operation by respective UE 101. As such, the hot key activation platform 111 may generate direct signal inputs by way of the operating system of the UE 101 for interacting with the application 107. In another embodiment, one or more of the modules 201-213 may be implemented for operation by respective UEs, as a hot key activation platform 111, or combination thereof. Still further, the hot key activation platform 111 may be integrated for direct operation with a service 103, such as in the form of a widget or applet, in accordance with an information and/or subscriber sharing arrangement. The various executions presented herein contemplate any and all arrangements and models.

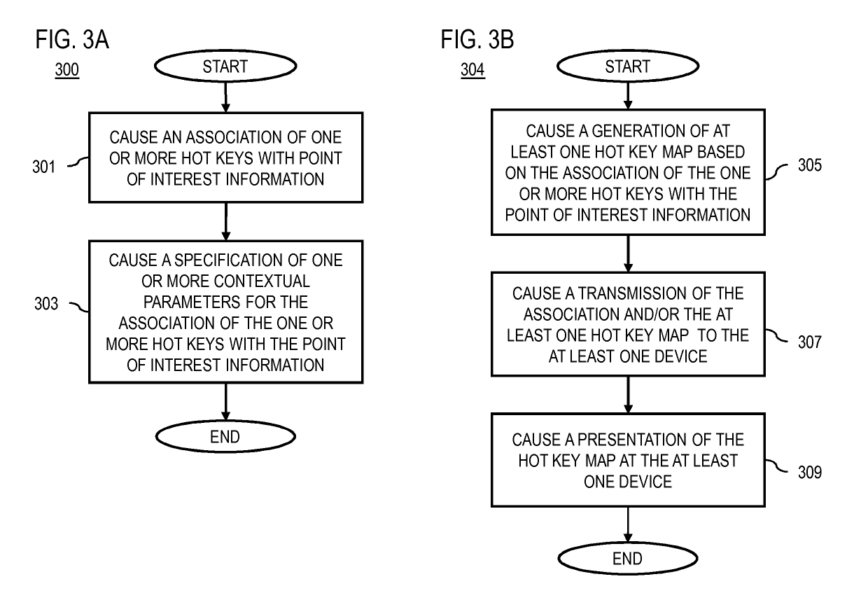

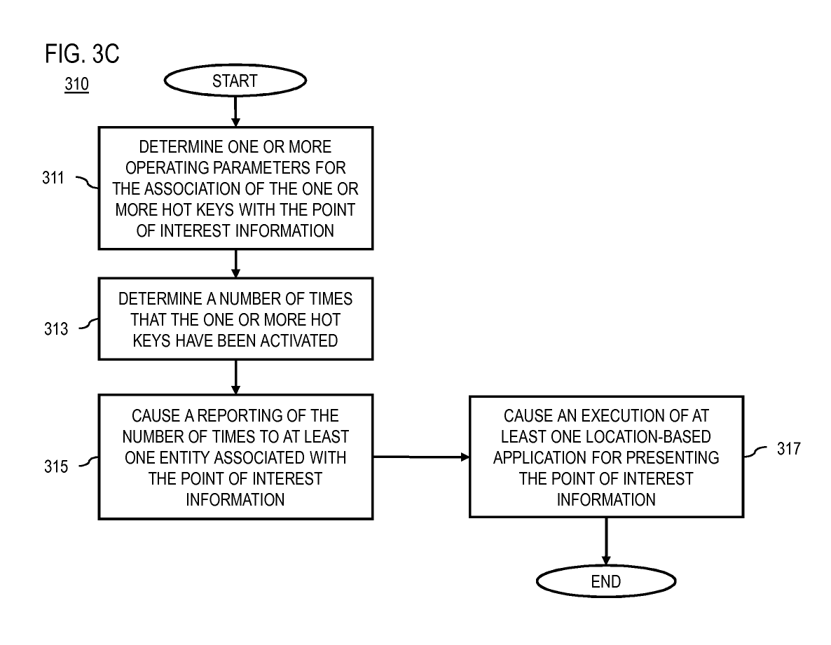

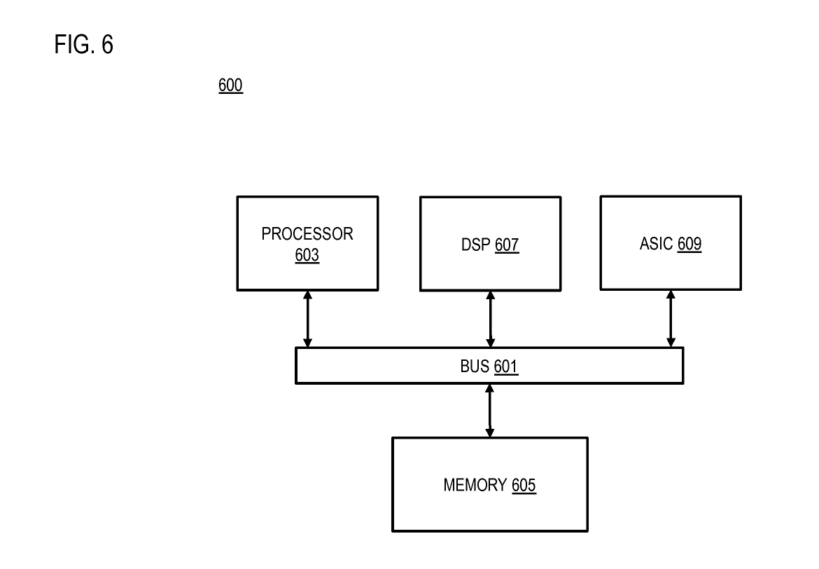

FIGS. 3A-3C are flowcharts of processes for associating one or more hot keys with point of interest information, according to various embodiments. In one embodiment, the hot key activation platform 111 performs processes 300, 304 and 310 and is implemented in, for instance, a chip set including a processor and a memory as shown in FIG. 6.

In step 301 of process 300 (FIG. 3A), the hot key activation platform 111 causes an association of one or more hot keys with point of interest information. As noted, activation of the one or more hot keys at at least one device causes, at least in part, a presentation of the point of interest information at the at least one device. In step 303, the platform 111 causes a specification of one or more contextual parameters for the association of the one or more hot keys with the point of interest information. By way of example, presentation of the point of interest information is based, at least in part, on the one or more contextual parameters. Also, the one or more contextual parameters include, at least in part, a temporal parameter, a location parameter, an activity parameter, or a combination thereof.

In step 305 of process 304 (FIG. 3B), the hot key activation platform 111 causes a generation of at least one hot key map based on the association of the one or more hot keys with the point of interest information. As noted previously, the hot key map provides a mapping between a hot key and the specific function to be invoked relative to corresponding POI information, the contextual parameters and the operating parameters. In another step 307, the platform 111 causes transmission of the association and/or the at least one hot key map to the at least one device.

In yet another step 309, the platform 111 causes a presentation of the hot key map at the at least one device. It is noted that the presentation of the hot key map is through broadcast programming including, at least in part, one or more radio broadcasts, one or more television broadcasts, or a combination thereof. It is noted that the hot key map may enable timing and/or programming information related to the broadcasts to be determined for enabling correlation of POI information with the broadcasts.

In step 311 of process 310 (FIG. 3C), the hot key activation platform 111 determines one or more operating parameters for the association of the one or more hot keys with the point of interest information. As noted previously, the one or more operating parameters include, at least in part, a period of time during which the association is active, one or more conditions under which the association is active, or a combination thereof.

Per step 313, the hot key activation platform 111 determines a number of times that the one or more hot keys have been activated. In step 315, the platform 111 also causes a reporting of the number of times to at least one entity associated with the point of interest information. As noted previously, the entity may include an advertiser or provider of the POI information; the report enabling the performance and/or effectiveness of the POI information to be monitored. In another step 317, the platform 111 causes an execution of at least one location-based application for presenting the point of interest information.

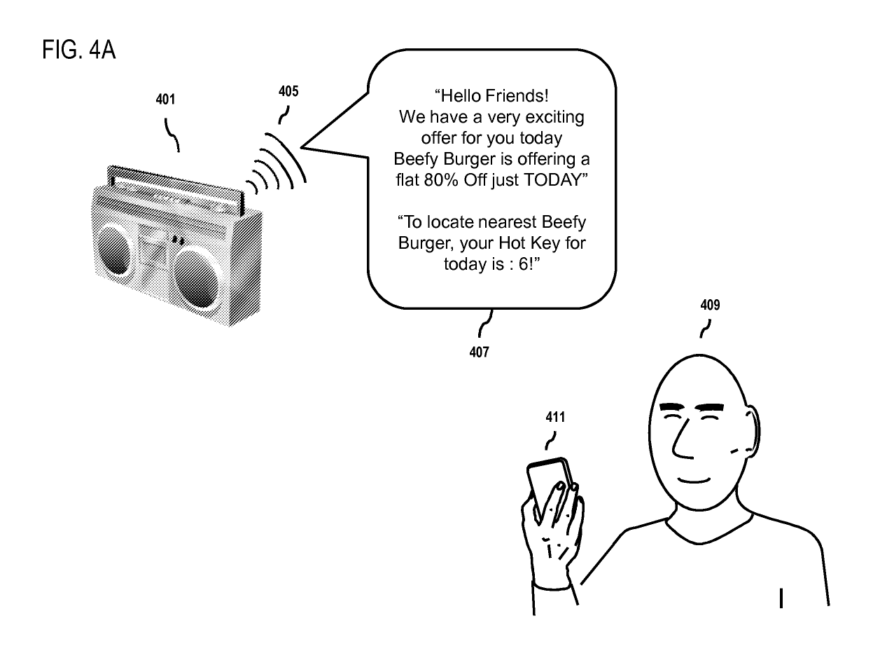

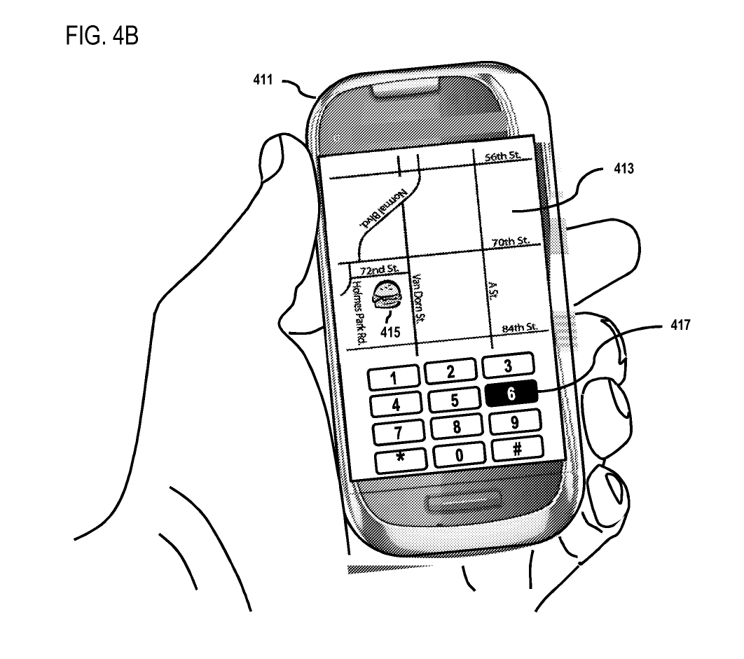

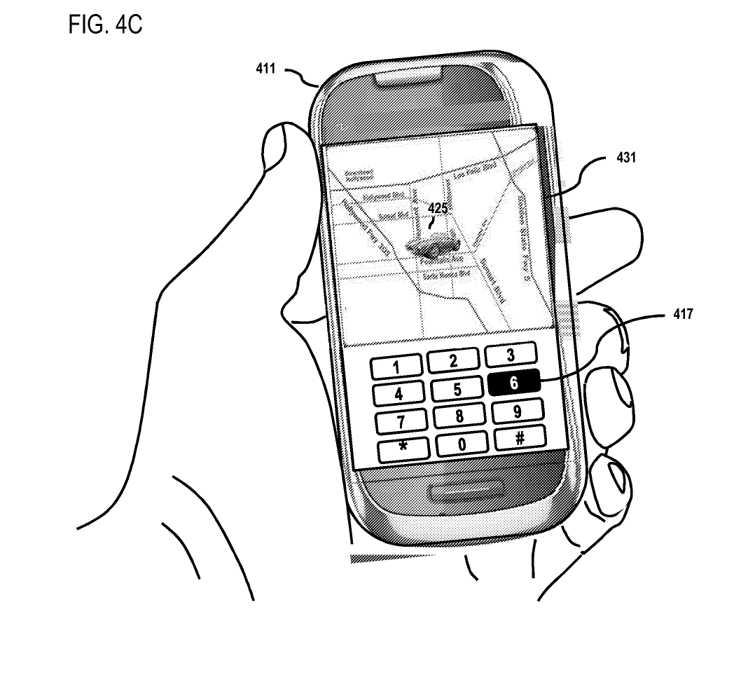

FIGS. 4A-4C are diagrams of user interfaces utilized in the processes of FIGS. 3A-3C, according to various embodiments. For the purpose of illustration, the diagrams are described with respect to an exemplary use case of a user 409 of a mobile device 411 interacting with the hot key activation platform 111 in response to POI information 407. In this example, the POI information 407 is conveyed to the user by way of a radio broadcast (e.g., signal 405), as per radio 401. It is noted, however, that the radio broadcast could be presented to the user via the mobile device 411—i.e., via a radio player application of the device 411.

In FIG. 4A, the user 409 happens to hear the POI information as they are walking past the radio 401. In this example, the POI information is conveyed as a radio 401 advertisement for indicating a discount offer for a restaurant (Beefy Burger). In addition to conveying details regarding the offer, an instruction is conveyed for indicating that a corresponding hot key for locating the nearest Beefy Burger is the dial pad key labeled “6” at the mobile device 411. Enticed by the offer, the user activates a mapping application of the mobile device 411, as depicted in FIG. 4B.

The mapping application 417 causes the sensors of the mobile device 411 to collect context information, including location information, temporal information and activity information. This information is then transmitted to the hot key activation platform 111, which performs a check to determine if the contextual parameters are sufficient for enabling the user to activate the hot key. In this case, the user is determined to be within range of a target location for execution of the offer. In addition, the current time is within a predetermined window of execution of the offer. Resultantly, the user is able to initiate presentment of POI information relative to the map interface 413 by pressing the appropriate hot key 417. In response to this activation, an icon 415 for depicting the POI corresponding to the broadcast 407 as referenced against the map is shown.

It is noted that the icon 415 as presented in connection with the map 413 depicts the nearest Beefy Burger location based on the location of the user 409. In addition, the icon 415 represents a participating Beefy Burger location—i.e., only the location where the advertised offer will be honored. This corresponds to instances where only select stores participate in the offer. Such criteria is determined to be fulfilled by the hot key activation platform 111 based on the hot key map data provided by a provider of the radio broadcast advertisement 407. The user 409 can optionally choose to save the POI information for future use.

In FIG. 4C, a mapping of the hot key to different POI information is depicted. In this case, when the user selects the same hot key 417, an icon 425 depicting a vehicle is presented against the map 431 for a different geographic location is shown. The icon 425 corresponds to POI information regarding a sports car advertisement as presented via a television broadcast. As noted, the hot key map maintained by the hot key activation platform 111 readily enables the hot keys to be assigned to different POI information accordingly for accommodating different contextual parameters (e.g., locations or times of day).

By way of the above described approaches and techniques, the ability of users to discover and exploration POI information relative to a map is enhanced. In addition, users that listen to or view broadcasts that feature advertisements may be more readily identify participating store and vendor locations that directly correlate to the POI information. Still further, providers of the POI information can directly measure the success of an advertisement based on the level of interaction of different device users with a hot key.

The processes described herein for associating one or more hot keys with point of interest information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

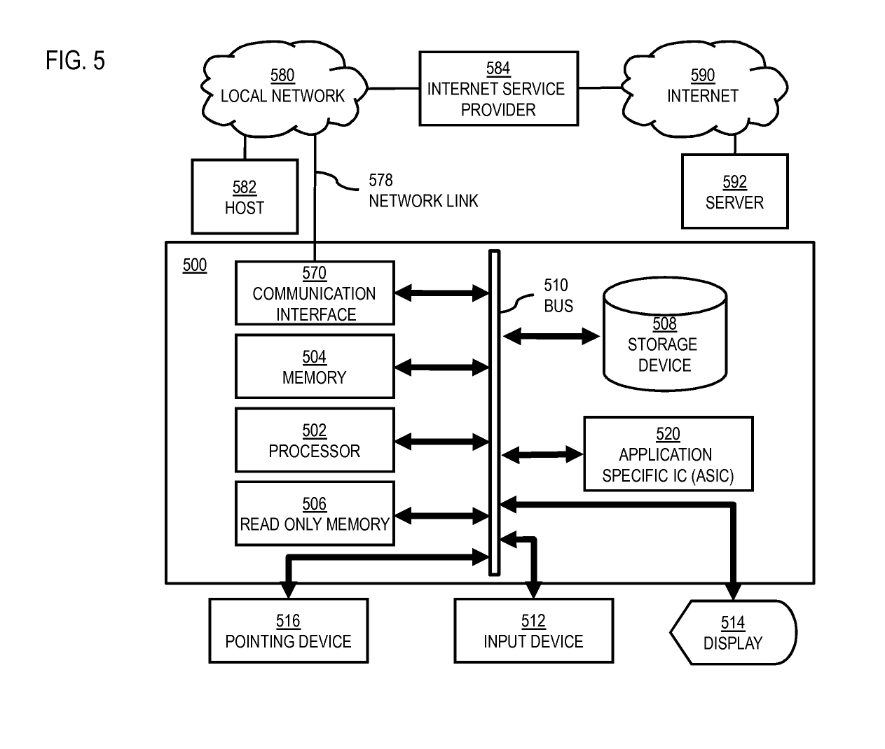

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to associate one or more hot keys with point of interest information as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of associating one or more hot keys with point of interest information.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to associate one or more hot keys with point of interest information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for associating one or more hot keys with point of interest information. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for associating one or more hot keys with point of interest information, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for associating one or more hot keys with point of interest information to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to associate one or more hot keys with point of interest information as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of associating one or more hot keys with point of interest information.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors. The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to associate one or more hot keys with point of interest information. The memory 605 also stores the data associated with or generated by the execution of the inventive steps.

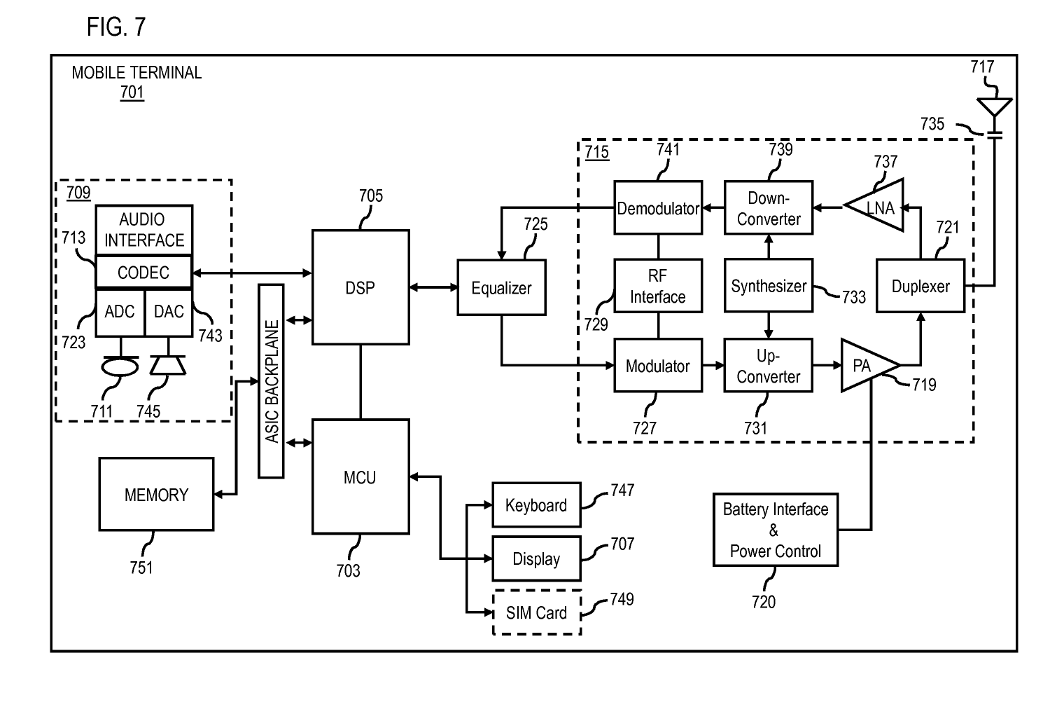

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of associating one or more hot keys with point of interest information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of associating one or more hot keys with point of interest information. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to associate one or more hot keys with point of interest information. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. An apparatus comprising:
at least one processor; and
at least one memory including computer program code for one or more programs,
the at least one memory and the computer program code configured to, with the at least one processor, cause the apparatus to perform at least the following,
cause, at least in part, an association of one or more hot keys with point of interest information,
wherein an activation of the one or more hot keys at least one device causes, at least in part, a presentation of the point of interest information at the at least one device.

40. An apparatus of claim 39, wherein the apparatus is further caused to:
cause, at least in part, a specification of one or more contextual parameters for the association of the one or more hot keys with the point of interest information,
wherein the presentation of the point of interest information is based, at least in part, on the one or more contextual parameters.

41. An apparatus of claim 40, wherein the one or more contextual parameters include, at least in part, a temporal parameter, a location parameter, an activity parameter, or a combination thereof.

42. An apparatus of claim 39, wherein the apparatus is further caused to:
cause, at least in part, a generation of at least one hot key map based, at least in part, on the association of the one or more hot keys with the point of interest information.

43. An apparatus of claim 42, wherein the apparatus is further caused to:
cause, at least in part, a transmission of the association, the at least one hot key map, or a combination thereof to the at least one device.

44. An apparatus of claim 42, wherein the apparatus is further caused to:
cause, at least in part, a presentation of the hot key map at the at least one device,
wherein the presentation of the hot key map is through broadcast programming including, at least in part, one or more radio broadcasts, one or more television broadcasts, one or more network broadcasts, or a combination thereof.

45. An apparatus of claim 39, wherein the apparatus is further caused to:
determine one or more operating parameters for the association of the one or more hot keys with the point of interest information.

46. An apparatus of claim 45, wherein the one or more operating parameters include, at least in part, a period of time during which the association is active, a proximity or location for which the association is active, one or more conditions under which the association is active, or a combination thereof.

47. An apparatus of claim 39, wherein the apparatus is further caused to:
determine a number of times that the one or more hot keys have been activated; and
cause, at least in part, a reporting of the number of times to at least one entity associated with the point of interest information.

48. A method comprising:
causing, at least in part, an association of one or more hot keys with point of interest information,
wherein an activation of the one or more hot keys at least one device causes, at least in part, a presentation of the point of interest information at the at least one device.

49. A method of claim 48, further comprising:
causing, at least in part, a specification of one or more contextual parameters for the association of the one or more hot keys with the point of interest information,
wherein the presentation of the point of interest information is based, at least in part, on the one or more contextual parameters.

50. A method of claim 49, wherein the one or more contextual parameters include, at least in part, a temporal parameter, a location parameter, an activity parameter, or a combination thereof.

51. A method of claim 48, further comprising:
causing, at least in part, a generation of at least one hot key map based, at least in part, on the association of the one or more hot keys with the point of interest information.

52. A method of claim 51, further comprising:
causing, at least in part, a transmission of the association, the at least one hot key map, or a combination thereof to the at least one device.

53. A method of claim 51, further comprising:
causing, at least in part, a presentation of the hot key map at the at least one device,
wherein the presentation of the hot key map is through broadcast programming including, at least in part, one or more radio broadcasts, one or more television broadcasts, one or more network broadcasts, or a combination thereof.

54. A method of claim 48, further comprising:
determining one or more operating parameters for the association of the one or more hot keys with the point of interest information.

55. A method of claim 54, wherein the one or more operating parameters include, at least in part, a period of time during which the association is active, a proximity or location for which the association is active, one or more conditions under which the association is active, or a combination thereof.

56. A method of claim 48, further comprising:
determining a number of times that the one or more hot keys have been activated; and
causing, at least in part, a reporting of the number of times to at least one entity associated with the point of interest information.

57. A computer program product including one or more sequences of one or more instructions which, when executed by one or more processors, cause an apparatus to at least perform the steps:
causing, at least in part, an association of one or more hot keys with point of interest information,
wherein an activation of the one or more hot keys at least one device causes, at least in part, a presentation of the point of interest information at the at least one device.

58. A computer program product of claim 57, wherein the apparatus is caused, at least in part, to further perform:
causing, at least in part, a specification of one or more contextual parameters for the association of the one or more hot keys with the point of interest information,
wherein the presentation of the point of interest information is based, at least in part, on the one or more contextual parameters.
